(19) United States
(12) Patent Application Publication
(10) Pub. No.: US 2014/0295368 A1
(43) Pub. Date: Oct. 2, 2014

(54) REFRACTORY PROTECTIVE MATERIAL FOR CLINKER FURNACES, WHICH PREVENTS THERMOCHEMICAL ATTACK WITHOUT THE FORMATION OF ENCRUSTATION OR RINGS

(71) Applicant: Refractaria, S.A., El Berron-Siero (ES)

(72) Inventors: Carlos Omar Suarez Alvarez, El Berron-Siero (ES); Jose Louis Pena Vazquez, El Berron-Siero (ES)

(73) Assignee: REFRACTARIA, S.A., El Berron-Siero (ES)

(21) Appl. No.: 14/351,570

(22) PCT Filed: Oct. 11, 2012
(86) PCT No.: PCT/ES2012/000265

§ 371 Date: Apr. 13, 2014

(30) Foreign Application Priority Data
Oct. 14, 2011 (ES) P201101133

(51) Int. Cl. C04B 35/10; F27D 1/00; F27B 7/28; C04B 35/18; C04B 35/185

(52) U.S. Cl. CPC C04B 35/10; C04B 35/18; C04B 35/185; F27B 7/28; F27D 1/0006
USPC 432/119; 501/89

(57) ABSTRACT

The invention relates to a refractory material for use in different parts of rotary furnaces, having a composition of minerals defined as a percentage by weight of sintered mullite or andalusite or sintered alumina or fused alumina or electrocast alumina-zirconium of between 30 and 80%, a percentage by weight of silicon carbide of between 5 and 15%. The material is used as a lining in rotary furnaces, for the precalciner, the smoke chamber, the furnace inlet, the burning area, the safety area, the furnace outlet area and the cooler.

### OBJECT OF THE INVENTION

The object of the present invention relates to a protective refractory material for clinker kilns which prevents thermochemical etching without the formation of crusting or rings such that it withstands thermochemical etching in cement kilns, extended to the transition, safety and burning zones without the lining producing any type of crusting, rings or gumming.

This new refractory material (refractory lining is fundamental in the performance of the rotary kiln as well as in the static parts of the clinker kiln since the durability of the refractory lining determines the durability of the kiln itself, which is a key factor in the economic performance of the cement industry) is applied in the inner linings of the cement kiln rotary part, in the lower transition zone, upper transition zone, safety zone and burning zone which, due to their special physicochemical characteristics, require substantial protection against chemical etching occurring in the process, as well as a higher pyroscopic resistance that can withstand isolated temperature increases and liquid phase formation occurring due to the use of alternative fuels in the cement industry. The foregoing will be discussed in the description of the invention below.

### BACKGROUND OF THE INVENTION

Rotary kilns are divided into six main zones, each of which is characterized by the type of refractory they require due to the temperatures reached and the reactions achieved therein. These zones include cooling zone, transition zone, clinkerization zone, upper transition zone, safety zone and burning zone. The lower transition zone, clinkerization zone and upper transition zone are lined with basic refractories where the main component is MgO (magnesium oxide). These refractory linings form a crust with the clinker in liquid phase which serves as a protection, thereby providing greater durability than other refractories.

These conventional zones of a clinker rotary kiln are:

Outlet zone (A): it has a length 0.5 times the diameter of the kiln. The cooled clinker is in solid state and produces high abrasion.

Lower transition zone (B): it has a length 1 time the diameter of the kiln, after the cooling zone. In this zone, clinker at 1450° C. is cooled below 1250° C. This zone is lined with basic refractory materials such that a crust protecting the surfaces of the lining which still contain liquid phase is formed.

Clinkerization zone (C): it has a length 5 times the diameter of the kiln, after the lower transition zone. The clinker is always kept in liquid phase with temperatures between 1400-1450° C. in order to carry out the necessary reactions for complete clinker formation. This zone is lined with basic refractory materials such that a crust protecting the surfaces of the lining is formed.

Upper transition zone (D): it has a length 2 times the diameter of the kiln, after the clinkerization zone. This is the zone prior to the liquid phase formation and it is lined with basic refractory so that the protective crust is formed in the case of isolated liquid phase formation.

Safety zone (E): it has a length 2 times the diameter of the kiln, after the upper transition zone. Aluminous refractory material is used in this zone with temperatures comprised between 1000 to 1200° C.

Burning zone (F): it extends from the end of the safety zone to the rotary kiln material inlet. Aluminous refractory material is used in this zone. The burning of materials coming from the precalciner entering the rotary kiln above 900° C. ends in this zone.

These zones are kept stable with the use of conventional fossil fuels in the cement industry, disruptions being rather unusual and cause of errors in the operations of the installation. In a continuous process such as the aforementioned, the stability of the zones directly influences process control and therefore the obtained product quality. However, in recent years the cement industry has begun to extensively use alternative fuels for burning in kilns. This technological change was spurred, among other reasons, by the need to achieve an economic performance through improved energy efficiency and by a clear commitment to environmental conservation and waste recovery. Alternative fuels are introduced either through the main burner of the rotary kiln or through the precalciner. The introduction of alternative fuels leads to significant fluctuations in the chemical and energy balances of the fuel. Despite the existence of systems for controlling the feeding of alternative fuels, their use may affect the desirable stable operating conditions to keep the process in each of the zones of the kiln under control. The instability of the temperatures and chemical reactions occurring in each zone is increasing not only due to the lack of homogeneity in each alternative fuel but also to the need for using several, very different types of alternative fuels, mainly due to availability issues. This instability causes frequent temperature increases in the lower transition zone, upper transition zone and safety zone causing a much more common existence of liquid phase in said zones. This leads to crusting and decrusting cycles which directly reduce the durability of basic refractories used in the lower and upper transition zones, given that the clinker entrains the outer layers of the refractory which is in contact with it with each decrusting cycle. Then there is the risk of losing entire zones of refractory lining due to the mechanical stress caused by the passage of clinker and rotation on accumulations of crusting in the decrusting phase. The mentioned factors generate stress which, combined with stress relief, can cause the loss of whole bricks in the lining, and taking into account that the loss of a single brick causes a lack of support in contiguous bricks, this would culminate in a failure that would entail the immediate emergency shutdown of the installation. Furthermore, the crusting-decrusting phenomenon even further complicates process control given that it radically changes the results of the thermography performed in the kiln shell.

The refractory material of the present invention which will withstand thermochemical etching existing in the lower transition zone, upper transition zone, safety zone and burning zone in the variables circumstances occurring with the use of alternative fuels without the formation of crusting or rings on the refractory lining, which will be described below, has been created to solve the aforementioned drawbacks.

### DESCRIPTION OF THE INVENTION

The object of this invention consists of a refractory formed by minerals that are carefully selected to achieve the physicochemical characteristics necessary to withstand new cement kiln conditions. A variable composition of andalusite (Al₂SiO₅), sintered mullite (3Al₂O₃.2SiO₂), sintered alumina, fused alumina (Al₂O₃), electrofused alumina-zirconium, silicon carbide (SiC), zirconium silicate (ZrSiO₄), and a refractory clay as an auxiliary element in the forming process, give the new refractory both chemical and physical properties that better withstand the operating conditions in cement installations.

Andalusite is an aluminum silicate (neosilicate) containing between 58 and 60% of Al₂O₃ and forming about 72% of the mullite phase through ceramic sintering. It has a high purity with low flux content, good thermal shock resistance, low porosity, low thermal conductivity, good refractoriness under load, good performance with respect to flow and excellent volumetric stability, in addition to having the property of being readily transformed into stable phase mullite at high temperature.

Sintered mullite is synthetically obtained through ceramic sintering in a rotary kiln from calcined alumina, bauxite and clay or kaolinite. Mullite is the only stable phase of the Al₂O₃—SiO₂ binary system. This artificially achieved stability confers very high chemical resistance properties as well as excellent physical properties at high temperatures to the raw material and therefore to the refractories in which the raw material is found.

Sintered alumina is a synthetic pure α-alumina material that has been densified by rapid sintering above 1800° C. with the aid of sintering agents. It has high volumetric stability at high temperature as well as excellent thermal shock resistance, high refractoriness, mechanical strength and abrasion, acid and alkali etching resistance, as well as resistance to other chemical agents.

Fused alumina or artificial corundum is also a pure a-alumina material that is very similar in many aspects to sintered alumina, although the manufacturing process is performed by fusion. It has excellent thermomechanical properties, high volumetric stability, refractoriness, chemical stability, mechanical strength and chemical etching and abrasion resistance.

Electrofused alumina-zirconium is a material which is produced by the solidification of an alumina and zirconium mixture which has been fused in an electric kiln and cast in a mold in liquid state. The composition of Al₂O₃ and ZrO₂ can vary, the different compositions of the material thus being obtained. It is a refractory material that is widely used as lining in the bedplate of glass furnaces. This suitably classified ground product can be used as the raw material of another refractory product, taking advantage of its excellent chemical etching resistance.

Silicon carbide is an artificial mineral manufactured from silica sand and petroleum coke in an electric kiln at temperatures close to 2200° C. with the following reaction:

SiO₂+3C →SiC+O₂

This raw material is extremely hard and has high abrasion resistance. It withstands corrosion when in contact with molten slag and has a low thermal expansion coefficient with excellent thermal spalling or breakage resistance.

Zirconium silicate or zircon (ZrSiO₄) is a naturally occurring mineral which is very hard, has a high specific gravity and high refractoriness. It in turn has high corrosion and chemical etching resistance.

Clays provide plastic characteristics to the refractory mixture object of the invention which are necessary for forming the refractory geometric shape.

Based on the foregoing, the new refractory invention is characterized by high chemical etching resistance, higher refractoriness than that of conventional refractories used in the zones of application of the cement kiln, lower thermal conductivity and optimal performance with respect to the formation of the types of deposition rings mentioned above.

These characteristics mean that the material object of the invention allows longer cement rotary kiln operation times due to its higher durability, which entails very significant economic savings by minimizing installation shutdowns due to constriction in the passage of the clinker through the kiln and deterioration of the refractory lining by chemical etching. It also better preserves the metal kiln shell conditions, reducing deformations caused by overheating of the metal part or the presence of hot spots therein.

As a result of its high refractoriness combined with its other properties, the new invention is very suitable for zones of the cement kiln in which other refractories do not withstand well the actual etching and thermal conditions of the rotary kiln process due to the introduction of alternative fuels, for example in zones such as the precalciner, where very significant additions of these recycled fuels take place with a rise in local temperature that leads to a higher rate of reactions that are undesirable for the refractory lining.

The new invention defines a specific chemical composition characterized by the addition of percentages by weight of the minerals described above, which can be combined in different proportions.

### DESCRIPTION OF THE DRAWINGS

To complement the description that is being made and for the purpose of aiding to better understand the features of the invention, a drawing is attached to the present specification as an integral part thereof in which the following has been depicted with an illustrative and non-limiting character:

FIG. 1 shows the different zones of the cement production rotary kiln.

### PREFERRED EMBODIMENT OF THE INVENTION

The refractory material of the present invention has the following variable composition that is described in the following examples:

### EXAMPLE 1

Andalusite (Al₂SiO₅), between 30 and 80%

Silicon carbide (SiC), between 5 and 60%

Zirconium silicate (ZrSiO₄), between 5 and 60%

Clay, between 5 and 15%

### EXAMPLE 2

Sintered mullite (3Al₂O₃.2SiO₂), between 30 and 80%

Silicon carbide (SiC), between 5 and 60%

Zirconium silicate (ZrSiO₄), between 5 and 60%

Clay, between 5 and 15%

### EXAMPLE 3

Sintered alumina (Al₂O₃), between 30 and 80%

Silicon carbide (SiC), between 5 and 60%

Zirconium silicate (ZrSiO₄), between 5 and 60%

Clay, between 5 and 15%

### EXAMPLE 4

Fused alumina (Al₂O₃), between 30 and 80%

Silicon carbide (SiC), between 5 and 60%

Zirconium silicate (ZrSiO₄), between 5 and 60%

Clay, between 5 and 15%

### EXAMPLE 5

Electrofused alumina-zirconium, between 30 and 80%

Silicon carbide (SiC), between 5 and 60%

Zirconium silicate (ZrSiO₄), between 5 and 60%

Clay, between 5 and 15%

### EXAMPLE 6

Andalusite (Al₂SiO₅), between 30 and 80%

Zirconium silicate (ZrSiO₄), between 5 and 60%

Clay, between 5 and 15%

### EXAMPLE 7

Sintered mullite (3Al₂O₃.2SiO₂), between 30 and 80%

Zirconium silicate (ZrSiO₄), between 5 and 60%

Clay, between 5 and 15%

### EXAMPLE 8

Sintered alumina (Al₂O₃), between 30 and 80%

Zirconium silicate (ZrSiO₄), between 5 and 60%

Clay, between 5 and 15%

### EXAMPLE 9

Fused alumina (Al₂O₃), between 30 and 80%

Zirconium silicate (ZrSiO₄), between 5 and 60%

Clay, between 5 and 15%

### EXAMPLE 10

Electrofused alumina-zirconium, between 30 and 80%

Zirconium silicate (ZrSiO₄), between 5 and 60%

Clay, between 5 and 15%

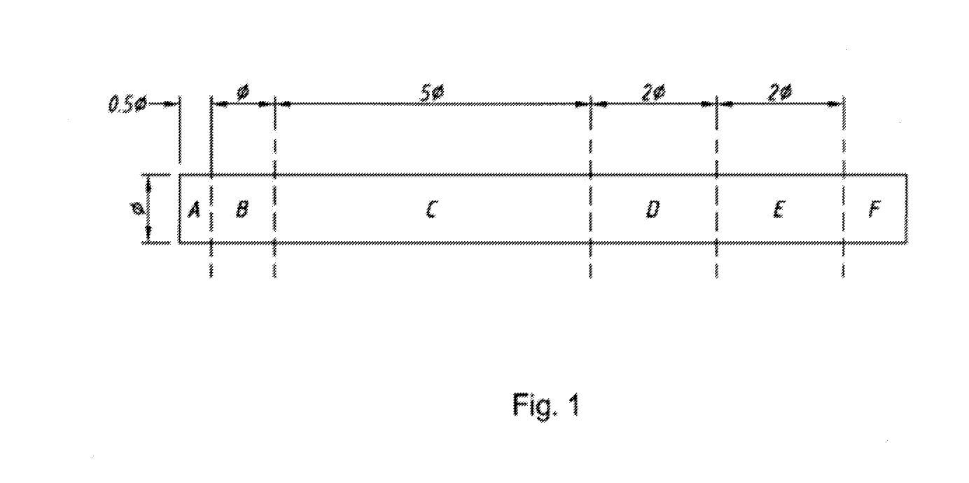

The zones of application of the new invention are perfectly defined in the cement rotary kiln, both in the types with a grate cooler and with a satellite cooler (see FIG. 1).

Outlet zone (A)

Lower transition zone (B)

Clinkerization zone (C)

Upper transition zone (D)

Safety zone (E)

Burning zone (F)

The refractory material object of the present invention, will be used in zones A, B, D, E and F

It is not considered necessary to broaden this description so that any person skilled in the art can comprehend the scope of the invention and the advantages derived from it. The terms used in drafting this specification must always be considered in a broad and non-limiting manner. The materials, shape, size and arrangement of the elements will generally be susceptible to variation provided that it does not involve an alteration to the essential features of the invention claimed below.

1. A protective refractory material for clinker kilns which prevents thermochemical etching without the formation of crusting or rings, of the type used in rotary kilns and particularly designed for use in different zones of said kiln, comprising a composition of minerals defined as a percentage by weight of a mineral selected from the group consisting of sintered mullite, andalusite, sintered alumina, fused alumina, electrofused alumina-zirconium and combinations thereof of between 30 and 80%, a percentage by weight of silicon carbide of between 5 and 60%, a percentage by weight of zirconium silicate of between 5 and 60% and a percentage of clay of between 5 and 15%.

2. The protective refractory material for clinker kilns which prevents thermochemical etching without the formation of crusting or rings according to claim 1, comprising a composition of minerals defined as a percentage by weight of sintered mullite or andalusite or sintered alumina or fused alumina or electrofused alumina-zirconium of between 30 and 80%, a percentage by weight of zirconium silicate of between 5 and 60% and a percentage of clay of between 5 and 15%.

3. The protective refractory material for clinker kilns which prevents thermochemical etching without the formation of crusting or rings according to claim 1 comprising the use thereof as an inner lining in rotary kilns of the cement industry for the burning zone, the safety zone, the upper transition zone, the lower transition zone and the outlet zone of the kiln.

4. A rotary kiln for use in the cement industry, comprising:
a safety zone, an upper transition zone, a lower transition zone, and an outlet zone, each having an inner liner containing a percentage by weight of a material selected from the group consisting of sintered mullite, andalusite, sintered alumina, fused alumina, electrofused alumina-zirconium and combinations thereof of between 30 and 80%, a percentage by weight of silicon carbide of between 5 and 60%, a percentage by weight of zirconium silicate of between 5 and 60% and a percentage of clay of between 5 and 15%.
